(19) United States
(12) Patent Application Publication
(10) Pub. No.: US 2023/0364607 A1
(43) Pub. Date: Nov. 16, 2023

(54) OPEN FLUIDIC DEVICE FOR AUTONOMOUS DROPLET GENERATION AND RELATED METHODS OF USE FOR DROPLET FORMATION AND MANIPULATION

(71) Applicant: University of Washington, Seattle, WA (US)

(72) Inventors: Jian Wei Khor, Seattle, WA (US); Ashleigh Brooks Theberge, Seattle, WA (US); Erwin Stefan Peter Berthier, Seattle, WA (US); Ulri Nicole Lee, Seattle, WA (US); Jean Berthier, Meylan (FR); Tristan Marriner Nicholson, Seattle, WA (US)

(73) Assignee: University of Washington, Seattle, WA (US)

(21) Appl. No.: 18/314,343

(22) Filed: May 9, 2023

Related U.S. Application Data
(60) Provisional application No. 63/340,205, filed on May 10, 2022.

(51) Int. Cl. B01L 3/00

(52) U.S. Cl. CPC B01L 3/502715; B01L 2200/0673; B01L 2400/022; B01L 2300/0816; B01L 2400/0406; B01L 2300/165

(57) ABSTRACT

Fluidic devices and methods for autonomous droplet generation and methods for droplet manipulation are described. In an embodiment, the fluidic device comprises a substrate defining: an inlet reservoir shaped to receive and to carry a carrier liquid; a converging region in fluidic communication with the inlet reservoir and shaped to receive a liquid sample; a constriction adjacent to and in fluidic communication with the converging region, wherein the constriction defines a pathway configured to allow passage of fluid therethrough; a diverging region in fluidic communication with and downstream of the constriction; and an outlet reservoir in fluidic communication with the diverging region, wherein the fluidic device does not comprise a portion covering the outlet reservoir opposite the substrate.

### CROSS-REFERENCE TO RELATED APPLICATIONS

This application claims the benefit of U.S. Provisional Application No. 63/340,205, filed on May 10, 2022, the disclosure of which is hereby incorporated by reference in its entirety.

### STATEMENT OF GOVERNMENT LICENSE RIGHTS

This invention was made with government support under Grant No. R35 GM128648, awarded by the National Institutes of Health (NIH). The government has certain rights in the invention.

### BACKGROUND

Droplet microfluidics enables compartmentalized reactions in small scales and has been utilized for a variety of applications across chemical analysis, material science, and biology. While droplet microfluidics is a successful technology, barriers include high “activation energy” to develop custom applications and complex peripheral equipment. These barriers limit the adoption of droplet microfluidics in labs or prototyping environments.

Prior methods for moving droplets within microfluidic devices such as electrowetting on dielectric optical tweezers, and complex valving systems require significant expertise.

### SUMMARY

To address these and related challenges, the present disclosure provides, in certain embodiments, an open channel droplet microfluidics system that autonomously generates droplets by utilizing competing hydrostatic and capillary pressure. With only devices disclosed herein, pipettes, and commercially available carrier fluid, it is possible to produce, for example, hundreds of microliter droplets; tubing, electronics, or pumps are not required, making droplet technology feasible for research labs without external flow generators. Furthermore, the present disclosure demonstrates applications that showcase the process of droplet generation, splitting, transport, incubation, mixing, and sorting in our system. Unlike conventional droplet microfluidics, the open nature of the devices disclosed herein enables the use of physical tools such as tweezers and styli to directly access the system; with this, the present disclosure provides a new method of droplet sorting and transfer that capitalizes on the Cheerios effect, i.e., the aggregation of buoyant objects along a liquid interface. The disclosed platform offers enhanced usability, direct access to the droplet contents, easy manufacturability, compact footprint, and high customizability.

Accordingly, in an aspect, the present disclosure provides a fluidic device for autonomous droplet generation. In an embodiment, the fluidic device comprises a substrate defining: an inlet reservoir shaped to receive and to carry a carrier liquid; a converging region in fluidic communication with the inlet reservoir and shaped to receive a liquid sample; a constriction adjacent to and in fluidic communication with the converging region, wherein the constriction defines a pathway configured to allow passage of fluid therethrough; a diverging region in fluidic communication with and downstream of the constriction; and an outlet reservoir in fluidic communication with the diverging region, wherein the fluidic device does not comprise a portion covering the outlet reservoir opposite the substrate.

In another aspect, the present disclosure provides a method of autonomous droplet generation. In an embodiment, the method comprises, introducing a liquid sample into a converging region shaped to receive the liquid sample; and introducing a carrier liquid into an inlet reservoir shaped to receive and to carry the carrier liquid, wherein the converging region is in fluidic communication with the inlet reservoir, thereby urging the liquid sample through a constriction adjacent to and in fluidic communication with the converging region and generating droplets into a diverging region in fluidic communication with and downstream of the constriction and an outlet reservoir in fluidic communication with the diverging region, wherein the fluidic device does not comprise a portion covering the outlet reservoir.

In an embodiment, the method is performed using a fluidic device according to any embodiment of the present disclosure or a kit according to any embodiment of the present disclosure.

In another aspect, the present disclosure provides a method of droplet manipulation. In an embodiment, the method comprises introducing a droplet manipulation instrument into a carrier liquid in which the droplet is disposed, wherein the droplet has a lower density than the carrier liquid, and wherein the carrier liquid wets the droplet manipulation instrument; and translating the droplet manipulation instrument through the carrier liquid adjacent to the droplet, thereby translating the droplet through the carrier liquid.

In an embodiment, the droplet is generated according to a method of autonomous droplet generation according to any embodiment of the present disclosure.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a schematic perspective illustration of a fluidic device, according to an embodiment of the present disclosure;

FIG. 1B is an image of generated droplets in an outlet reservoir of a fluidic device according to an embodiment of the present disclosure;

FIG. 1C is an image of droplets generated in parallel in a fluidic device, according to an embodiment of the present disclosure;

FIG. 1D schematically illustrates an example workflow for droplet generation using passive forces derived from pressure (hydrostatic pressure and capillary pressure) in a fluidic device, according to an embodiment of the present disclosure;

FIG. 1E illustrates examples of droplet manipulation downstream of droplet generation, according to embodiments of the present disclosure;

FIG. 1F is another perspective illustration of the fluidic device of FIG. 1A;

FIG. 1G is a plan view of the fluidic device of FIG. 1A;

FIG. 1H is a cross-section view of a portion of the fluidic device of FIG. 1A;

FIG. 2A is a schematic illustration of phases observed during droplet formation, according to an embodiment of the present disclosure;

FIG. 2B provides images of droplet formation at a constriction of a fluidic device corresponding to phases illustrated in FIG. 2A at various constriction width and surfactant concentration, according to an embodiment of the present disclosure;

FIG. 2C schematically illustrates hydrostatic pressure overcoming capillary pressure resulting in the aqueous plug being extruded or generating droplets at the constriction, in an embodiment of the present disclosure;

FIG. 3A is a regime map of plug extrusion and droplet generation with theoretical threshold (dashed line per Eq. (2)) with experimental data points of plug extrusion, droplet generation, and no plug extrusion, according to embodiments of the present disclosure;

FIG. 3B is a montage of plug extrusion and droplet generation when varying constriction width w and fluorinated surfactant concentration c, in which fluorinated surfactant concentration varies interfacial tension γ_{1,2} and contact angle θ_{1,2,s}, according to embodiments of the present disclosure;

FIG. 4A graphically illustrates droplet volume as a function of constriction width with varying concentrations of surfactant, according to embodiments of the present disclosure;

FIG. 4B graphically illustrates droplet volume as a function of constriction length with varying constriction width and length, according to embodiments of the present disclosure;

FIG. 4C graphically illustrates droplet volume as a function of constriction height with varying constriction width and length, according to embodiments of the present disclosure;

FIG. 5A schematically illustrates two neighboring buoyant objects aggregating where the buoyant object deforms the surface of the liquid resulting in a rising interface, and when a second buoyant object is near it tends to float up the rising interface, and tweezers and PTFE stylus behave similarly because they also deform the surface, so the droplets tend to aggregate towards them, according to embodiments of the present disclosure;

FIG. 5B schematically illustrates picking up droplets from an open fluidic device and transferring them to another location with tweezers, according to an embodiment of the present disclosure,

FIG. 5C schematically illustrates transporting droplets from one wall to another with a ball mounted on a stylus, according to an embodiment of the present disclosure;

FIG. 6A schematically illustrates and provides images of selectively retrieving droplets from an open microfluidic device and transferring them to a well plate with tweezers, according to an embodiment of the present disclosure;

FIG. 6B schematically illustrates and provides images of sorting droplets into individual chambers with a ball mounted on a stylus, according to an embodiment of the present disclosure;

FIG. 6C schematically illustrates and provides images of using a stylus to transfer droplets to a pillar, according to an embodiment of the present disclosure;

FIG. 7A schematically illustrates and provides images of a fluidic device including crenulations along an outlet reservoir wall as an aqueous plug passes the crenulations and small droplets split off and remains in the crenulations, according to an embodiment of the present disclosure;

FIG. 7B schematically illustrates and provides images of droplets merged by mixing with a needle to form a mixed droplet, according to an embodiment of the present disclosure;

FIG. 8A schematically illustrates a perspective view of a fluidic device according to an embodiment of the present disclosure;

FIG. 8B provides images of parallel droplet formation and transporting droplets, according to an embodiment of the present disclosure;

FIG. 8C provides images of droplet merging according to embodiments of the present disclosure;

FIG. 8D provides images of droplet sorting according to embodiments of the present disclosure.

### DETAILED DESCRIPTION

The present disclosure demonstrates, in certain embodiments, droplet generation by an open microfluidic channel using passive forces alone. The present disclosure also demonstrates downstream manipulations that are enabled by the open nature of the systems of the present disclosure. Such devices and methods of the present disclosure open new avenues in droplet microfluidics, a field which has grown immensely in the past decade. Droplet microfluidics is a powerful technology that uses microliter to picoliter droplets as chambers to conduct biological or chemical analyses and has many important applications in DNA sequencing, directed evolution, materials chemistry, and chemical reactions. Droplet microfluidics is an attractive technology because it can provide high throughput, miniaturizes chemical and biological processes, reduces reagent waste, and enables the use of precious or expensive reagents. Additionally, droplet manipulations such as sorting, mixing, and splitting are empowering for expanding potential applications of droplet microfluidics.

The systems of the present disclosure are configured to autonomously generate the droplets by leveraging hydrostatic pressure differences between the two immiscible fluids (e.g., a fluorinated carrier phase and an aqueous phase), capillary pressure, and spontaneous capillary flow (SCF). Hydrostatic pressure is governed by the carrier fluid height (determined by the dimensions of the device) and density, while capillary pressure is governed by interfacial tension, contact angle, and meniscus radius of curvature. SCF is a capillary flow that can be induced by balancing the wettability of the material and the dimensions of the channel through which the fluid is flowing. Additionally, SCF can be observed in open microfluidic or mesofluidic channels where at least one side of the channel is open to the air. Unlike conventional droplet microfluidics, the fluidic devices of the present disclosure comprise, in certain embodiments, one side of a channel exposed. The open surface of the channel provides access to the channel that conventional droplet microfluidics with closed, walled off channels does not. For example, a user can directly pipette into the channel or add/retrieve droplets, solid objects such as magnetic beads, or tissue samples. Methods of using the devices of the present disclosure enable a user to deliver an aqueous phase, followed by the carrier phase or carrier liquid, each in a single pipetting step, to initiate the generation of droplets. In this regard, there is no need for continuous pipetting or monitoring as in prior systems. The SCF-driven droplet generation methods of the present disclosure eliminate the need for external flow generators, expanding the accessibility of droplet microfluidics to labs without flow generators and opening up possibilities for novel applications that are not feasible in devices requiring electricity.

The open-channel droplet generating systems of the present disclosure are distinct from this prior work at least in that they are configured to spontaneously generate droplets in an open channel without any externally applied flow and without the direct actuation of a pipette to generate each droplet. Furthermore, in contrast to prior systems, the carrier fluid used in certain examples to generate and transport droplets in our system (HFE fluorinated oil) is commonly used for biological applications of droplet microfluidics, thus making the systems and methods of the present disclosure compatible for biological experiments. The work of Soitu et al. and Li et al. highlighted the importance of manipulations of droplets for cell biology in their systems where droplets were formed under an immiscible phase by segmenting aqueous solution with a physical stylus and simple pipetting. The systems and methods of the present disclosure provide advances over and are complementary to these two methods because the droplets are self-generating in an open system where they can then be manipulated for biological applications. Other methods to generate droplets using pipettes include simple agitation of a biphasic solution either with or without cavity-containing microparticles.

As described further herein, the present disclosure provides a theoretical model to describe the phenomenon observed. The model is derived from the pressure difference between hydrostatic pressures and capillary pressures across the aqueous plug, and a critical threshold for droplet generation is found. Both the experimental results and theoretical model show that interfacial tension, contact angle, and constriction width play roles in droplet generation. The present disclosure also provides a suite of droplet manipulation techniques that capitalize on the open nature of our devices, including novel methods for moving droplets with a specialized stylus or tweezers to sort and transfer droplets within a device or into another device or well plate.

Accordingly, in an aspect, the present disclosure provides a fluidic device for autonomous droplet generation, the fluidic device comprising: a substrate defining: an inlet reservoir shaped to receive and to carry a carrier liquid; a converging region in fluidic communication with the inlet reservoir and shaped to receive a liquid sample; a constriction adjacent to and in fluidic communication with the converging region, wherein the constriction defines a pathway configured to allow passage of fluid therethrough; a diverging region in fluidic communication with and downstream of the constriction; and an outlet reservoir in fluidic communication with the diverging region, wherein the fluidic device does not comprise a portion covering the outlet reservoir opposite the substrate.

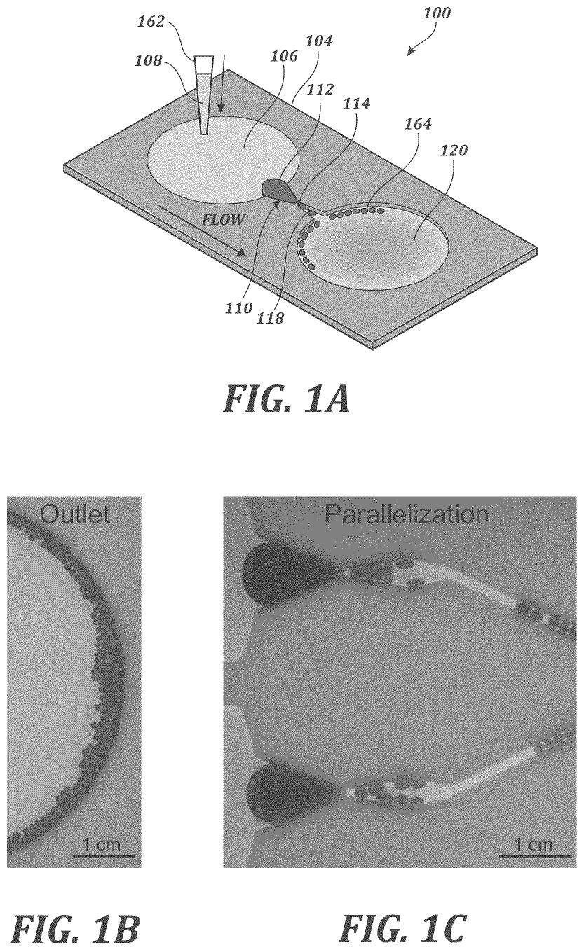

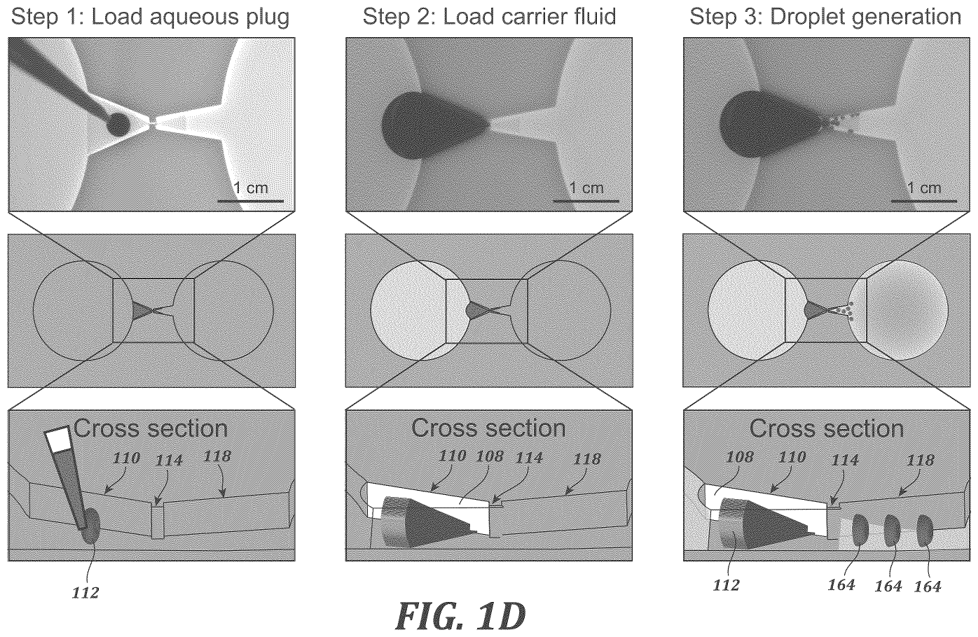

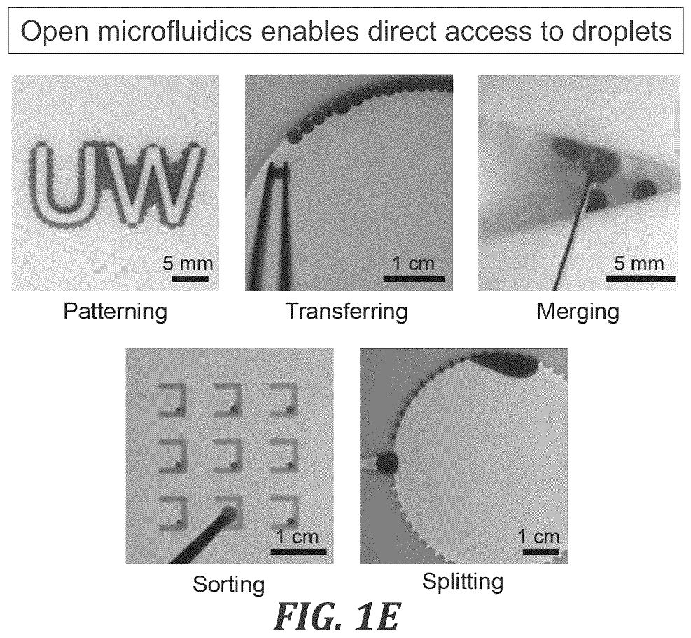

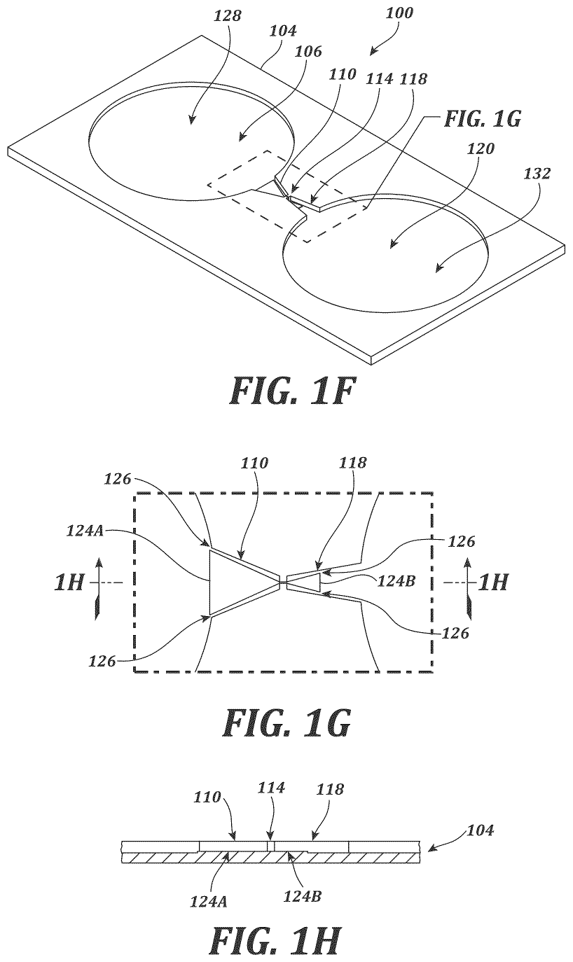

In this regard, attention is directed to FIGS. 1A-1H in which a fluidic device according to an embodiment of the present disclosure is illustrated. FIG. 1A is a schematic perspective illustration of a fluidic device 100. FIG. 1B is an image of generated droplets in an outlet reservoir 120 of a fluidic device 100. FIG. 1C is an image of droplets generated in parallel in a fluidic device 100. FIG. 1D schematically illustrates an example workflow for droplet generation using passive forces derived from pressure (hydrostatic pressure and capillary pressure) in a fluidic device 100. FIG. 1E illustrates examples of droplet manipulation downstream of droplet generation. FIG. 1F is another perspective illustration of the fluidic device 100. FIG. 1G is a plan view of the fluidic device 100. FIG. 1H is a cross-section view of a portion of the fluidic device 100.

As shown, in particular, in FIGS. 1A, 1F, 1G, and 1H, the fluidic device 100 is shown to include a substrate 104 defining a number of structures for autonomous droplet generation. In the illustrated embodiment, the substrate 104 is shown to define or otherwise comprise an inlet reservoir 106 shaped to receive and to carry a carrier liquid 108; a converging region 110 in fluidic communication with the inlet reservoir 106 and shaped to receive a liquid sample 112; a constriction 114 adjacent to and in fluidic communication with the converging region 110, wherein the constriction 114 defines a pathway configured to allow passage of fluid therethrough; a diverging region 118 in fluidic communication with and downstream of the constriction 114; and an outlet reservoir 120 in fluidic communication with the diverging region 118.

As shown, the fluidic device 100 does not comprise a portion covering the outlet reservoir 120 opposite the substrate 104. In this regard, and as discussed further herein, the fluidic device 100 and contents disposed therein are open to a surrounding environment of the fluidic device 100. In this regard, the fluidic device 100 is shown to define a substrate 104 and walls encircling the substrate 104, such as to be configured to carry a liquid therein. However, in an embodiment, the fluidic device 100 does not include a roof or other structure covering the device, such as to limit access to the channel. In this regard, in an embodiment, the fluidic device 100 does not comprise roof or other structure covering one or more of the inlet reservoir 106, the converging region 110, the constriction 114, the diverging region 118, or the outlet reservoir 120.

As above, the fluidic device 100 comprises an inlet reservoir 106 shaped to receive and to carry a carrier liquid 108. As discussed further herein, the fluidic devices are configured to use competing hydrostatic and capillary forces to generate droplets 164. In this regard, carrier liquid 108 carried by the inlet reservoir 106 generates hydrostatic pressure configured to urge a liquid sample 112 through constriction 114, where hydrostatic pressure is governed by the carrier liquid 108 height (determined by the dimensions of the fluidic device 100) and density of the carrier liquid 108. Hydrostatic pressure can be adjusted by adjusting these parameters.

As shown, the fluidic device 100 comprises a converging region 110 in fluidic communication with the inlet reservoir 106 and shaped to receive a liquid sample 112. In the illustrated embodiment, the converging region 110 defines an opening in a wall of the inlet reservoir 106 to converge toward the constriction 114. In an embodiment, an angle of the converging region 110 relative to a flow axis of the constriction 114 is in a range of about 10° to about 60°. In an embodiment, an angle of the converging region 110 relative to a flow axis of the constriction 114 is about 45°.

As illustrated in, for example, FIG. 1A, the converging region 110 is configured to receive a liquid sample 112, such as an aqueous liquid sample 112. In an example, the converging region 110 is shaped and positioned to receive the liquid sample 112, such as when deposited in the converging region 110 with a pipette. In the illustrated embodiment, the converging region 110 defines a wedge converging, at a wider end, from the inlet reservoir 106 to the constriction 114 at a narrower end.

As shown, the constriction 114 is adjacent to and in fluidic communication with the converging region 110, wherein the constriction 114 defines a pathway configured to allow passage of fluid therethrough. In this regard, when the liquid sample 112 is placed in the converging region 110 and, for example, the carrier liquid 108 is placed in the inlet reservoir 106, the converging region 110 and the diverging region 118 are cooperatively configured to urge the liquid sample 112 through the constriction 114, such as in the form of one or more droplets 164, for example, when the liquid sample 112 overcomes a difference between hydrostatic and capillary pressure which pushes it into the narrow constriction 114.

In the illustrated embodiment, the constriction 114 comprises a pair of protrusions 122 extending from the converging region 110 and the diverging region 118. In this regard, the protrusions 122 may be disposed at or within the constriction 114. In an embodiment, a sidewall of the fluidic device 100 defines the pair of protrusions 122, which at least in part comprise the structures of the constriction 114.

In an embodiment, a width of the constriction 114 is in a range of about 0.2 mm to about 0.3 mm. While these particular values are described and demonstrated herein, it will be understood that other ranges of constrictions are within the scope of the present disclosure.

In an embodiment, the substrate 104 comprises a hydrophobic material. In an embodiment, the substrate 104 comprises, such as at the constriction, 114 and/or on a surface of the fluidic device 100 comprises poly(tetrafluoro ethylene) (PTFE). As discussed elsewhere herein, such a hydrophobic material can be configured to autonomously generate droplets 164 through the constriction 114. While PTFE is described, it will be understood that other hydrophobic materials are possible and within the scope of the present disclosure. Further, it will be understood that hydrophobicity of the materials used may be conducive to forming droplets 164 from different combinations of carrier fluid and liquid samples, depending, for example, on densities, hydrophobicities, etc. of the carrier fluid and liquid samples used.

In an embodiment, the hydrophobic material is configured such that a droplet of an aqueous solution in contact with the hydrophobic material has a contact angle in a range of about 0° to about 90°.

As shown, a portion of the substrate 104 including and surrounding the constriction 114 comprises a floor. As also shown, the floor defines one or more grooves 126 shaped and positioned to transport a carrier liquid 108 between the converging region 110 and the diverging region 118. Such one or more grooves 126 are configured to allow passage of carrier fluid through the constriction 114, and are, thereby, configured to autonomously generate droplets 164 of a liquid sample 112. In the illustrated embodiment, the substrate 104 is shown to include floor protrusions 124A and 124B extending from the inlet floor 128, thus defining at least in part the one or more grooves 126.

The fluidic device 100 is configured to autonomously generate droplets 164 of the liquid sample 112 when the carrier liquid 108 is disposed in the inlet reservoir 106. In this regard, in an embodiment, the fluidic device 100 does not comprise a pump or other powered devices configured to urge liquid, such as the liquid sample 112, through the constriction 114 to generate droplets 164 therewith. Such pumps or powered devices are unnecessary.

As above, the fluidic device 100 comprises a diverging region 118 in fluidic communication with and downstream of the constriction 114; and an outlet reservoir 120 in fluidic communication with the diverging region 118.

As shown, the diverging region 118 diverges from a flow axis of the constriction 114 forming a wedge emanating from the constriction 114. In an embodiment, an angle of the diverging region 118 relative to the flow axis is in a range of about 5° to about 30°. In an embodiment, an angle of the diverging region 118 relative to the flow axis is 20°.

The outlet reservoir 120 is shown adjacent to and downstream of the diverging region 118. In this regard, the outlet reservoir 120 is positioned to receive the liquid sample 112 having passed through the constriction 114, such as in the form of one or more droplets 164.

In an embodiment, the outlet reservoir 120 defines a floor and a wall encircling at least a portion of the floor, wherein the outlet reservoir 120 is configured to receive and carry droplets 164 generated at the constriction 114.

As shown, the outlet floor 132 defines floor protrusions 124A and 124B defining one or more grooves 126. The one or more grooves 126 in the outlet floor 132 are positioned downstream and in registry with the one or more grooves 126 of the inlet reservoir 106. In the illustrated embodiment, the floor protrusions 124A and 124B are shaped to define the one or more grooves 126 as roughly parallel to the converging region 110 and the diverging region 118 such that the one or more grooves 126 run along the converging region 110 and the diverging region 118. See, for example, FIG. 1G.

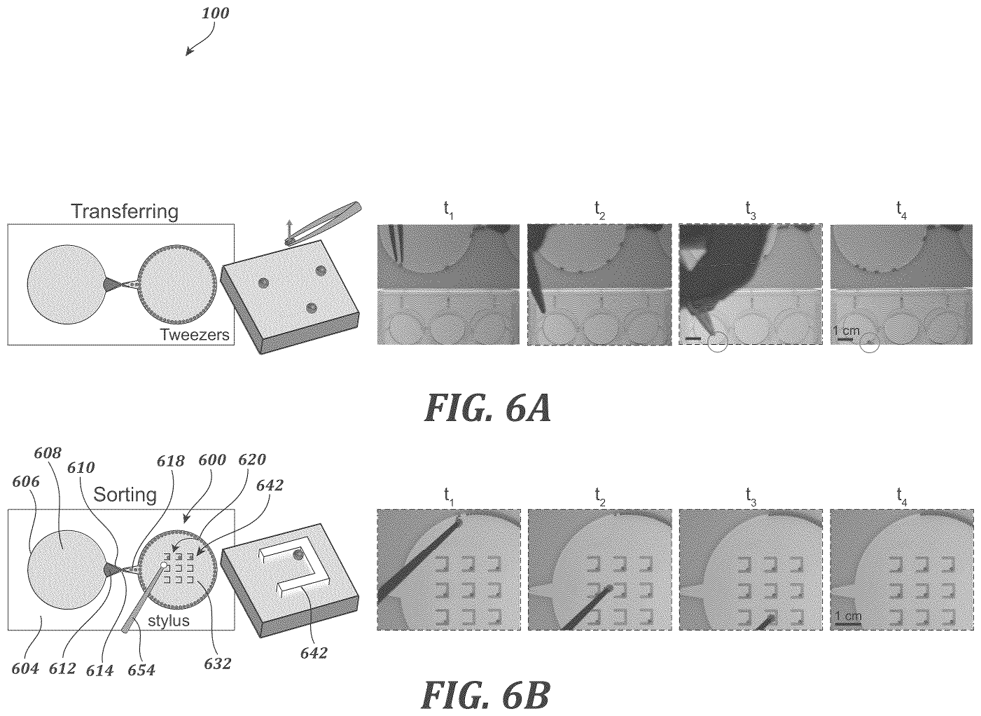

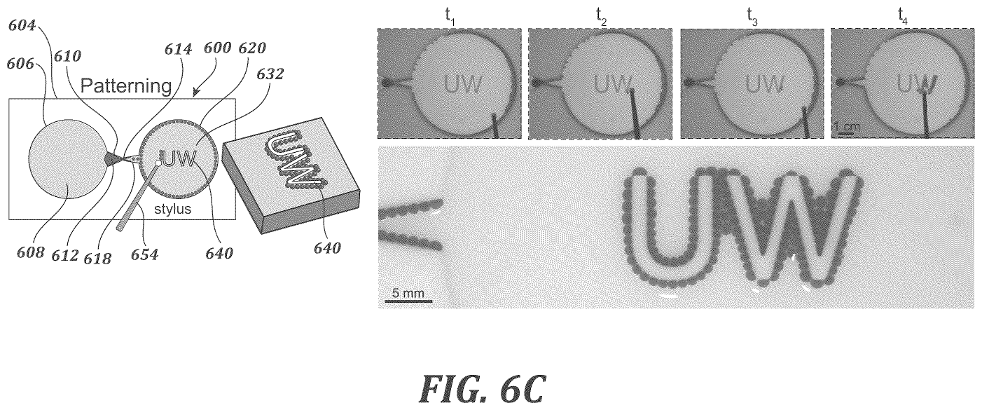

In an embodiment, the fluidic devices of the present disclosure include structures configured to adhere to a droplet, such as configured to adhere to a droplet generated at a constriction. In this regard, attention is directed to FIGS. 6B and 6C in which fluidic devices 600 according to embodiments of the present disclosure are illustrated.

Referring to FIG. 6B, the fluidic device 600 is shown to include a substrate 604 defining an inlet reservoir 606 shaped to receive and to carry a carrier liquid 608; a converging region 610 in fluidic communication with the inlet reservoir 606 and shaped to receive a liquid sample 612; a constriction 614 adjacent to and in fluidic communication with the converging region 610, wherein the constriction 614 defines a pathway configured to allow passage of fluid therethrough; a diverging region 618 in fluidic communication with and downstream of the constriction 614; and an outlet reservoir 620 in fluidic communication with the diverging region 618. In an embodiment, the fluidic device 600 is an example of the fluidic device 100 described further herein with respect to FIGS. 1A and 1F-1H.

As also shown, the fluidic device 600 includes an array of chambers 642 disposed in and extending out of the outlet floor 632. In the illustrated embodiment, the chambers 642 define an inlet shaped to receive one or more droplets, the inlet facing the diverging region 618 from which the one or more droplets may eject. As shown, the chambers 642 comprise three adjacent and adjoining walls.

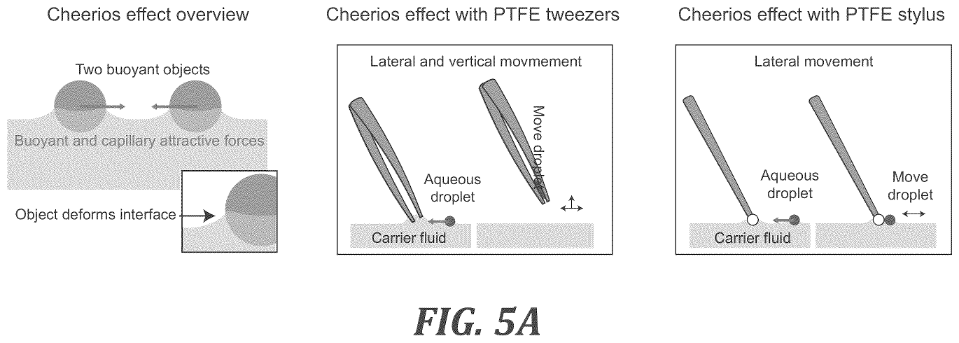

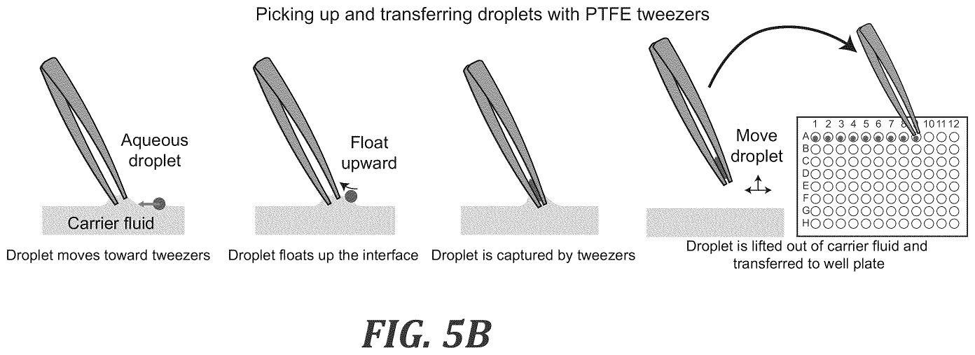

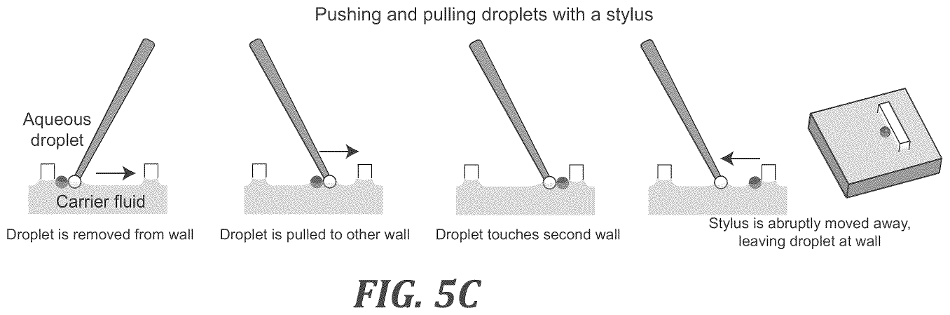

While such a u-shaped structure is illustrated, it will be understood that other structures and shapes configured to adhere to a droplet are possible and within the scope of the present disclosure. In this regard, attention is directed to FIG. 6C. The fluidic device 600 of FIG. 6C includes many of the structures and components described further herein with respect to FIGS. 1A, 1F-1H, and 6B. In this regard, the fluidic device 600 is shown to include a substrate 604 defining an inlet reservoir 606 shaped to receive and to carry a carrier liquid 608; a converging region 610 in fluidic communication with the inlet reservoir 606 and shaped to receive a liquid sample 612; a constriction 614 adjacent to and in fluidic communication with the converging region 610, wherein the constriction 614 defines a pathway configured to allow passage of fluid therethrough; a diverging region 618 in fluidic communication with and downstream of the constriction 614; and an outlet reservoir 620 in fluidic communication with the diverging region 618. As also shown, the fluidic device 600 comprises a structure 640 disposed in and extending from the outlet floor 632 a structure configured to adhere to one or more droplets. As shown in the illustrated embodiment, the structure 640, when viewed from above as in FIG. 6C defines the letters UW. While the letters UW are illustrated, it will be understood that other shapes and structures 640 are possible and within the scope of the present disclosure. See, for example, FIG. 5C.

As described elsewhere herein, when a carrier liquid 608 and structures have the same or similar hydrophobicities, a surface of the structure is wet by the carrier liquid 608. Further, when the liquid sample 612 has a density lower than the carrier liquid 608, droplets of the liquid sample 612 tend to adhere to the structures. See, for example, FIG. 5C.

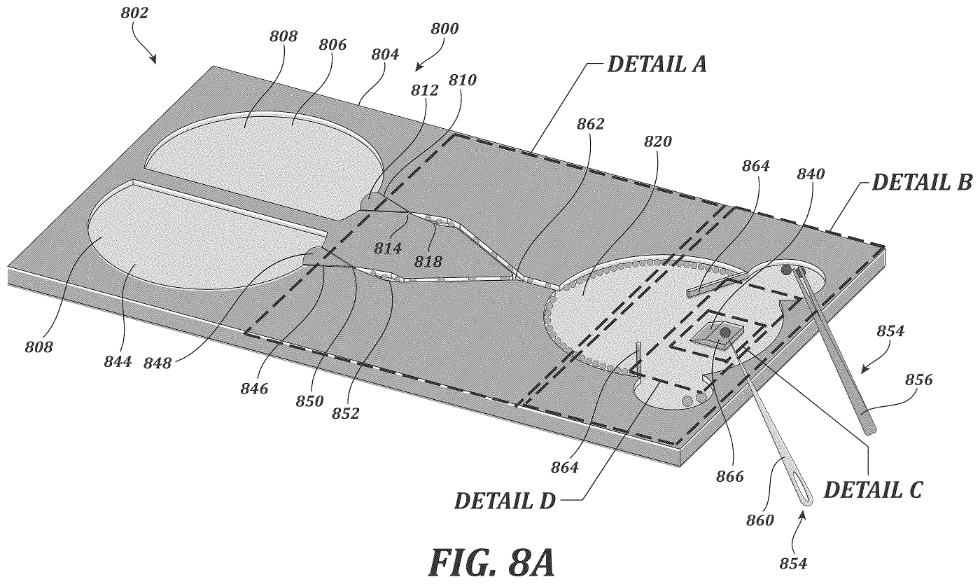

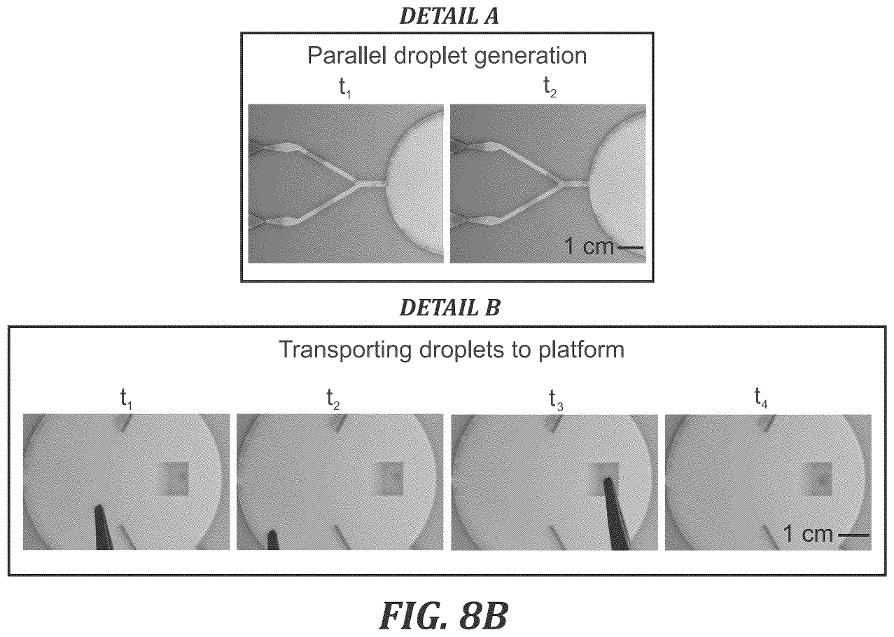

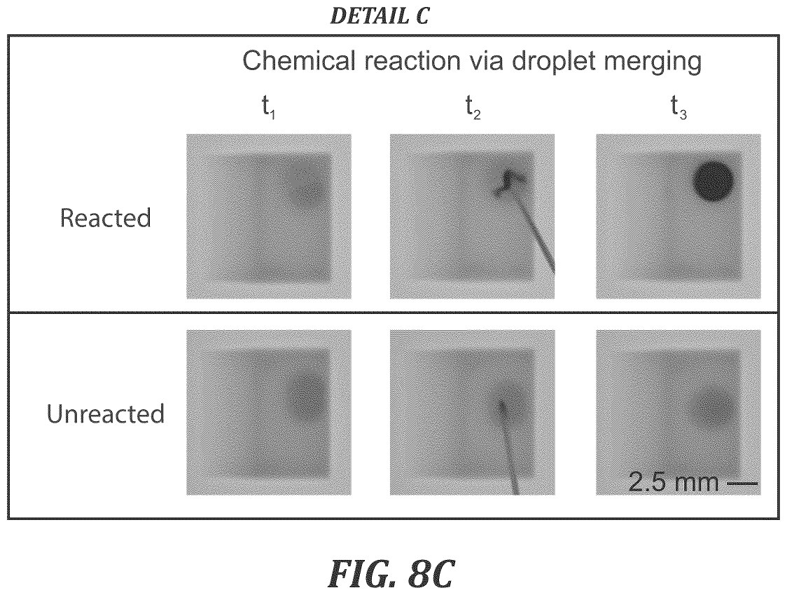

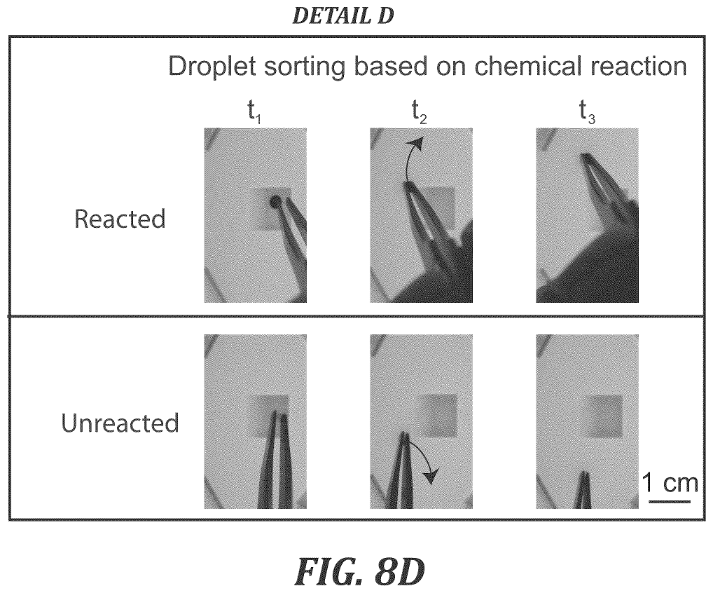

The kits of FIGS. 6B and 6C are shown to further include droplet manipulation instruments 654 configured to manipulate droplets, such as to move droplets, as described further herein such as with respect to FIG. 8A.

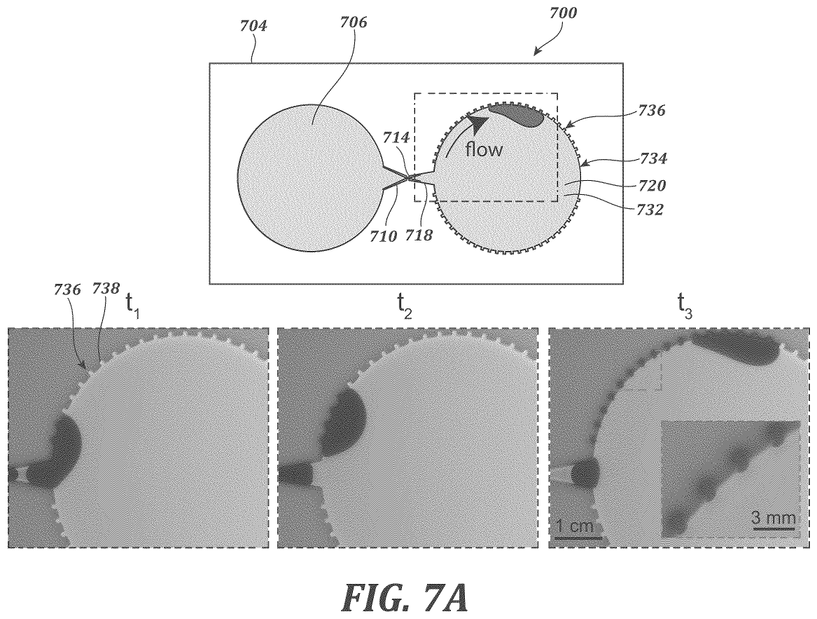

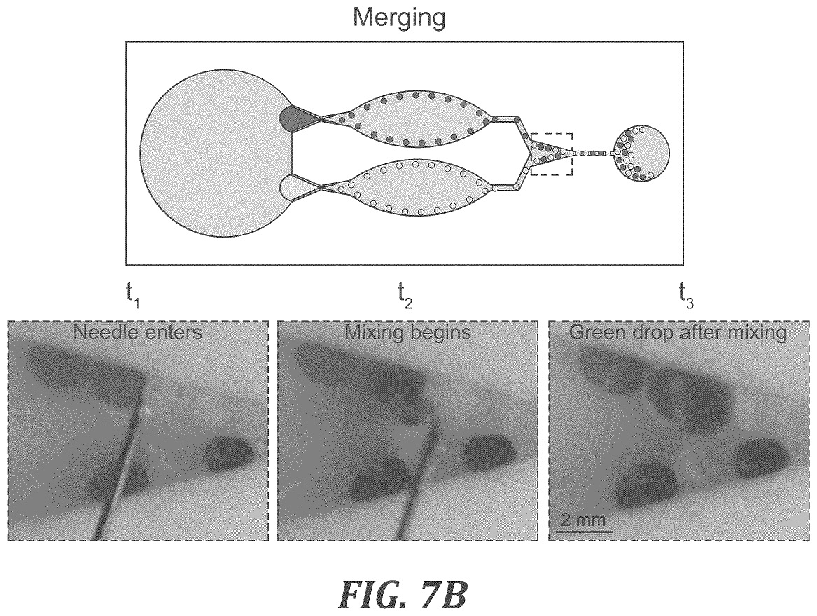

In an embodiment, the fluidic devices of the present disclosure include outlet reservoirs defining structures for droplet generation. In this regard, attention is directed to FIG. 7A in which a fluidic device 700 according to an embodiment of the present disclosure is illustrated.

As shown, the fluidic device 700 is shown to include a substrate 704 defining an inlet reservoir 706 shaped to receive and to carry a carrier liquid 708; a converging region 710 in fluidic communication with the inlet reservoir 706 and shaped to receive a liquid sample 712; a constriction 714 adjacent to and in fluidic communication with the converging region 710, wherein the constriction 714 defines a pathway configured to allow passage of fluid therethrough; a diverging region 718 in fluidic communication with and downstream of the constriction 714; and an outlet reservoir 720 in fluidic communication with the diverging region 718. In an embodiment, the fluidic device 700 is an example of the fluidic device 100 described further herein with respect to FIGS. 1A and 1F-1H.

In the illustrated embodiment, the outlet reservoir 720 is shown to define a floor 732 and a wall encircling at least a portion of the floor 732. In this regard, the outlet reservoir 720 is shaped, positioned, and otherwise configured to receive and carry droplets generated at the constriction 714. As also shown, the wall defines a plurality of crenulations 736 shaped to generate a droplet within interstices 738 of a crenulation of the plurality of crenulations 736. As illustrated in panels t1, t2, and t3 of FIG. 7A, as a plug of a liquid sample 712 passes over the wall including the plurality of crenulations 736, and the carrier liquid 708 subsequently passes over the wall, droplets of the liquid sample 712 remain in the interstices 738 of the crenulations 736. In this regard, the fluidic device 700 is configured to form droplets with the constriction 714, as discussed further herein with respect to, for example, FIGS. 1A and 1F-1H, and with the plurality of crenulations 736.

While crenulations 736 formed in a wall of the outlet reservoir 720 are described, it will be understood that other structures formed, for example, in the outlet reservoir 720 are possible and within the scope of the present disclosure.

In an embodiment, the fluidic devices of the present disclosure are configured to generate two or more pluralities of droplets, such as simultaneously generate two or more pluralities of droplets in parallel. As discussed further herein, in certain such embodiments, the droplets generated in parallel can include different reagents and/or samples that can be merged downstream, such as in an outlet reservoir 820. In this regard, attention is now directed to FIG. 8A in which a kit 802 comprising a fluidic device 800 according to an embodiment of the present disclosure is illustrated.

While the kit 802 is shown to include the fluidic device 800, it will be understood that kits of the present disclosure can include fluidic devices according to any embodiment of the present disclosure, such as fluidic devices 100, 600, and 700 discussed further herein with respect to FIGS. 1A and 1F-1H, FIGS. 6A and 6B, and FIG. 7A, respectively.

As shown, the fluidic device 800 includes an inlet reservoir 806 shaped to receive and to carry a carrier liquid 808; a converging region 810 in fluidic communication with the inlet reservoir 806 and shaped to receive a liquid sample 812; a constriction 814 adjacent to and in fluidic communication with the converging region 810, wherein the constriction 814 defines a pathway configured to allow passage of fluid therethrough; a diverging region 818 in fluidic communication with and downstream of the constriction 814; and an outlet reservoir 820 in fluidic communication with the diverging region 818.

In the illustrated embodiment, the inlet reservoir 806 is a first inlet reservoir 806, the constriction 814 is a first constriction 814, the converging region 810 is a first converging region 810, and the diverging region 818 is a first diverging region 818. Further, the fluidic device 800 is shown to comprise a second inlet reservoir 844 shaped to receive and to carry the carrier liquid 808; a second converging region 846 in fluidic communication with the second inlet reservoir 844 and shaped to receive a second liquid sample 848; a second constriction 850 adjacent to and in fluidic communication with the second converging region 846; a second diverging region 852 in fluidic communication with and downstream of the second constriction 850, wherein the second diverging region 852 is shaped and positioned to transport droplets generated at the second constriction 850 to the outlet reservoir 820. Another example of such an embodiment is illustrated in, for example, FIG. 1C.

Referring again to FIG. 8A, the fluidic device 800 is shown to generate and is configured to generate, such as to autonomously generate, droplets with each of constriction 850 and constriction 814. In the illustrated embodiment, the droplets are separately generated in constriction 850 and constriction 814 merge in droplet randomizing channel 862. The droplet randomizing channel 862 is shaped and positioned to receive droplets from each constriction 850 and 814 and, depending on when a droplet is received from its respective constriction 850 or 814, the droplets may intersperse or be randomized in their order within the droplet randomizing channel 862.

After combining in the droplet randomizing channel 862, droplets proceed into the outlet reservoir 820. As shown, the outlet reservoir 820 defines a floor and a wall encircling at least a portion of the floor such that the outlet reservoir 820 is configured to receive and carry droplets generated at the constrictions 814 and 850.

As shown, the substrate 804 defines two barriers 864 positioned in the wall of the outlet reservoir 820 positioned to stop or limit flow of droplets in the outlet reservoir 820. In this regard, as droplets emerge from the diverging region 818, the droplets adhere to the wall of the outlet reservoir 820. The barriers 864 extend from a downstream portion of the wall and into the outlet reservoir 820 to limit flow of the droplets into a manipulation portion of the outlet reservoir 820.

In the illustrated embodiment, the floor defines one or more structures shaped to adhere to a droplet generated at the constrictions 814 and 850. In this regard, the floor defines a chamber 866 shaped to receive a droplet. In the illustrated embodiment, the fluidic device 800 comprises a fusion platform 866 shaped to receive and carry a droplet, such as for manipulation of the droplet.

As shown, the kit 802 further includes one or more droplet manipulation instruments 854 configured to move a droplet within the carrier liquid 808. Such droplet manipulation instruments 854 can be configured to translate the droplet from one portion of the fluidic device 800 to another. In an embodiment, the droplet manipulation instruments 854 are configured to merge two or more droplets into a single combined droplet, such as by piercing the two or more droplets which subsequently combine.

In an embodiment, the droplet manipulation instrument 854 is selected from the group consisting of tweezers 856, a stylus (not shown, see FIG. 6B), a needle 860, and combinations thereof. As shown, the kit 802 includes two droplet manipulation instruments 854: a set of tweezers 856 and a needle 860.

In an embodiment, a portion of the droplet manipulation instrument 854 is coated in a material also comprised in the substrate 804 of the fluidic device 800. In this regard, in an embodiment, the droplet manipulation instrument 854 comprises a rod coupled to a ball comprising a material used in the substrate 804 of the fluidic device 800. See, for example FIG. 5C illustrating a stylus comprising a PTFE ball, wherein one or more portions of the fluidic device 800, such as the substrate 804, also comprise PTFE. As described elsewhere herein, a carrier liquid 808 having a similar hydrophobicity to that of the substrate 804 can be useful in manipulating droplets in that the droplets will adhere the substrate 804. Similarly, by using the same or similar materials in portions of a droplet manipulation instrument 854 shaped to contact a droplet, the droplets can be manipulated (e.g., translated, directed, etc.) with the droplet manipulation instrument 854.

In an embodiment, the kit 802 further comprises a carrier liquid 808. As described elsewhere herein, in an embodiment, the carrier liquid 808 is configured to and suitable for autonomously generating droplets in conjunction with the fluidic devices of the kits. In an embodiment, the carrier liquid 808 is a hydrophobic liquid. In an embodiment, the carrier liquid 808 is immiscible with a liquid sample 812, such as a liquid sample 812 comprising an aqueous solution or aqueous suspension. In this regard, the carrier liquid 808 is configured to form droplets with an aqueous liquid sample 812. In an embodiment, the carrier liquid 808 is a fluorinated liquid, such as a fluorinated oil. In an embodiment, the carrier liquid 808 comprises one or more hydrofluoroethers (HFE).

In an embodiment, the carrier liquid 808 has a similar hydrophobicity to that of the substrate 804, in particular portions of the substrate 804 configured to contact the carrier liquid 808, such as the constriction 814 and one or more channels (not pictured, see for example, FIGS. 1F-1G). In an embodiment, a droplet of the carrier liquid 808 in contact with the substrate 804 has a contact angle in in a range of about 0° to about 90°. In this regard, the carrier liquid 808 is configured to wet the substrate 804, rather than be repelled by the substrate 804.

In an embodiment, the fluidic device 800 is configured to autonomously generate droplets, such as when a liquid sample 812 is disposed in the converging region 810 and the carrier liquid 808 is disposed in the inlet reservoir 806. In an embodiment, a liquid sample 812 overcomes a difference between hydrostatic and capillary pressure which pushes the liquid sample 812 into the constriction 814, thereby, for example, generating droplets of the liquid sample 812.

As discussed elsewhere herein, droplet generation can be a function of constriction 814 width, carrier liquid 808 density, and an interfacial tension between the carrier liquid 808 and the liquid sample 812. In this regard, in an embodiment, a width, w, of a constriction 814 of the fluidic device 800 is according to the following equation:

$$w > \frac{2 {γ}_{1 , 2} \vert cos cos {θ}_{1 , 2 , s} \vert}{ρ g h}$$

where g is the gravitational acceleration, γ_{1,2} is the interfacial tension between the carrier liquid 808 and liquid sample 812, ρ is the carrier liquid 808 density, Rₚₒₛ is a radius of curvature of a back of an aqueous plug interface, and Rₐₙₜ is a radius of curvature of a front of the plug interface, θ_{1,2,s} is a contact angle between the aqueous plug, carrier fluid, and channel wall, and h is a carrier fluid height in the inlet reservoir 806. In such a configuration, autonomous droplet formation is possible.

Accordingly, in certain embodiments, for an aqueous plug interface to extend past the constriction 814, a hydrostatic pressure, ρgh at the back of the plug overcomes the capillary pressure, γ_{1,2}(1/Rₚₒₛ−1/Rₐₙₜ). In this regard, the fluidic device 800 is configured to balance the wettability of the material and the dimensions of the channel through which the fluid is flowing.

While these relationships are discussed with respect to constriction 814, analogous principles apply to constriction 850.

In an embodiment, the kit 802 includes one or more surfactants. Such one or more surfactants can adjust contact angles between an aqueous plug, the carrier liquid 808, and channel wall. Concentrations of surfactants suitable for autonomous droplet generation with the fluidic device 800 of the present disclosure can be determined experimentally by those of skill in the art. In this regard, based on the present disclosure, one of ordinary skill in the art will be able, for example, to measure contact angles to determine concentrations appropriate for droplet generation.

In another aspect the present disclosure provides methods, such as a method of autonomous droplet generation. In an embodiment, the methods of the present disclosure are methods of using the fluidic devices of the present disclosure, such as the fluidic devices described further herein with respect to FIGS. 1A, 1F-H, 6B, 6C, 7A, and 8A, among others.

In an embodiment, the method comprises introducing a liquid sample into a converging region shaped to receive the liquid sample; and introducing a carrier liquid into an inlet reservoir shaped to receive and to carry the carrier liquid, wherein the converging region is in fluidic communication with the inlet reservoir, thereby urging the liquid sample through a constriction adjacent to and in fluidic communication with the converging region and generating droplets into a diverging region in fluidic communication with and downstream of the constriction and an outlet reservoir in fluidic communication with the diverging region, wherein the fluidic device does not comprise a portion covering the outlet reservoir.

In an embodiment, the method is performed using a fluidic device according to any embodiment of the present disclosure or a kit according to any embodiment of the present disclosure.

In an embodiment, the liquid sample is or comprises a sperm sample.

In an embodiment, the method is method of droplet manipulation. In an embodiment, the method comprises introducing a droplet manipulation instrument into a carrier liquid in which the droplet is disposed, wherein the droplet has a lower density than the carrier liquid, and wherein the carrier liquid wets the droplet manipulation instrument; and translating the droplet manipulation instrument through the carrier liquid adjacent to the droplet, thereby translating the droplet through the carrier liquid.

In an embodiment, the droplet is generated according to the method of autonomous droplet generation. In an embodiment, the method comprises merging the droplet with another droplet.

### EXAMPLES

### Example 1: Materials and Methods

Channel Design and Fabrication.

The channels were designed in Solidworks (Dassault Systemes SE) and postprocessed in Fusion 360 (Autodesk, Inc.). Then, they were fabricated out of 3.2 mm thick PTFE (McMaster-Carr Supply Co.) on a Datron NEO mill (Datron Dynamics Inc.). After the channels were milled, they were rinsed with deionized water (DIW), sonicated in 70% ethanol for 30 min, and then rinsed again with DIW. Finally, the channels were dried with compressed air.

The channel height is 1.6 mm, and the width of the narrow constriction ranges between 0.2 mm and 3.0 mm. There is also a platform with a height of 0.2 mm at the narrow constriction and converging-diverging region to allow the aqueous plug to be pinned at the constriction entrance to produce consistent droplet generation. The channel has a square cross section. The converging part of the tapered channel is 45°, and diverging is 20° as these angles were found to be the best at generating monodisperse droplets consistently. The square protrusions that form the channel constriction are 1 mm wide.

General Reagents.

Carrier fluids used were pure HFE 7500 (The 3M Co.), HFE 7500 with 0.002 wt %, 0.02 wt %, 0.2 wt %, and 2 wt % Rhodamine fluorosurfactant (RAN Biotechnologies Inc.). The Rhodamine fluorosurfactant (FS) is a mix of fluorosurfactant 008FS (008-FluoroSurfactant) and Rhodamine-functionalized fluorosurfactant Rhod-FS (FS-Rhodamine) (FS is a mix of 008FS and Rhod-FS with weight ratio of 3:1 respectively). The aqueous phase, DIW, is mixed with blue food dye (McCormick Corp.).

Image Acquisition Setup.

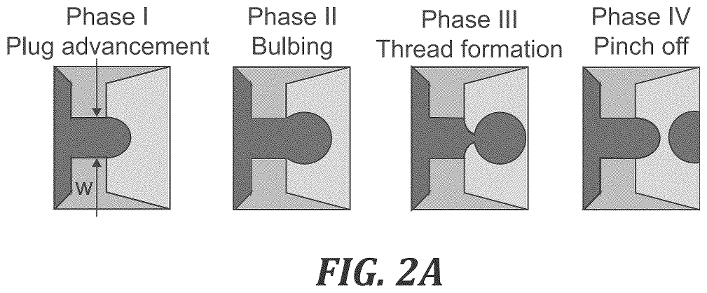

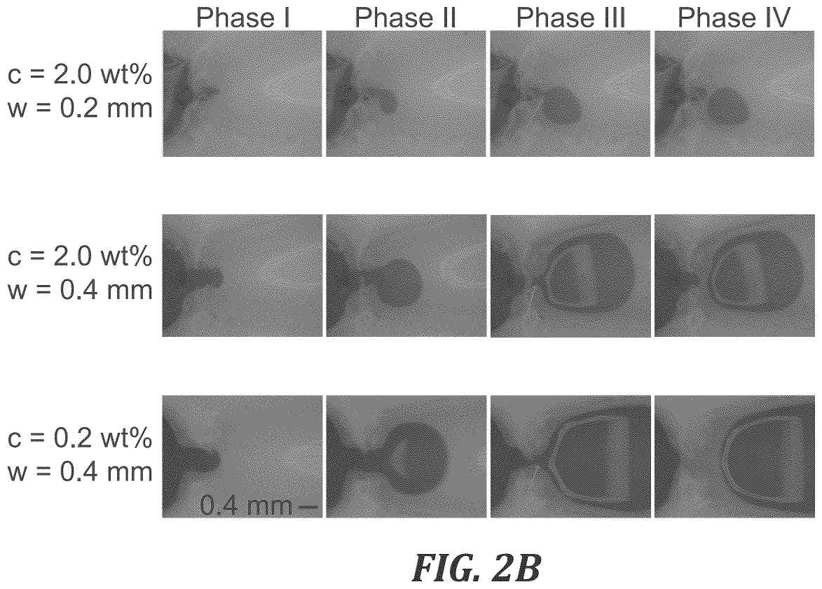

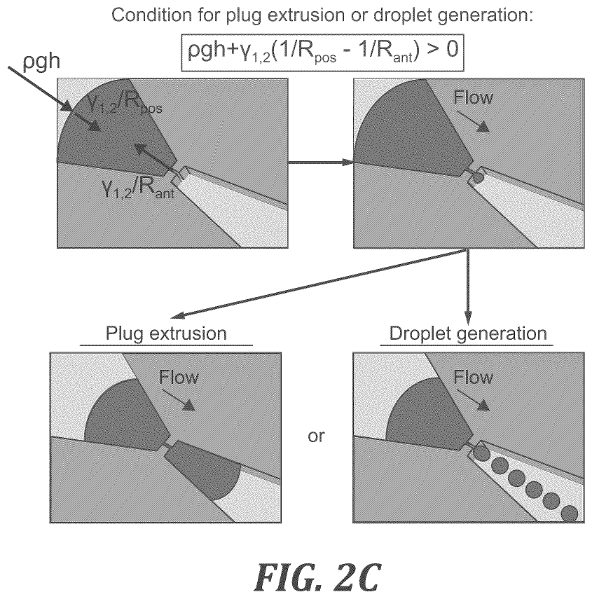

A Nikon-D5300 DSLR camera attached to a jig with adjustable distance was used to record the experimental results at the top view of the channel and at a frame rate of 30 fps. For the high-speed video in FIG. 2b, a Chronos 1.4 high-speed camera (Kron Technologies Inc.) was installed on a stereoscope (United Scope LLC) to record the droplet generation at 2577 fps.

Droplet Generation.

A 180 μL DIW plug containing food dye was pipetted on the platform in the channel and then 2 mL of carrier fluid was pipetted into the inlet reservoir of the channel to generate water droplets ranging from 0.52 μL to 34.55 μL (see FIG. 1D). Generated droplet volume takes 1-2 minutes to stabilize and generate consistent droplet volume.

It was found that droplet generation is initiated faster when the channel is placed at a slight incline of 3°. Placing the channel on an incline did not result in a significant change in the generated droplet volume. Thus, in the proof of concept demonstrating the sorting of reacted products in droplets (FIG. 8), the channel was placed at an incline.

Contact Angle and Interfacial Tension Measurements.

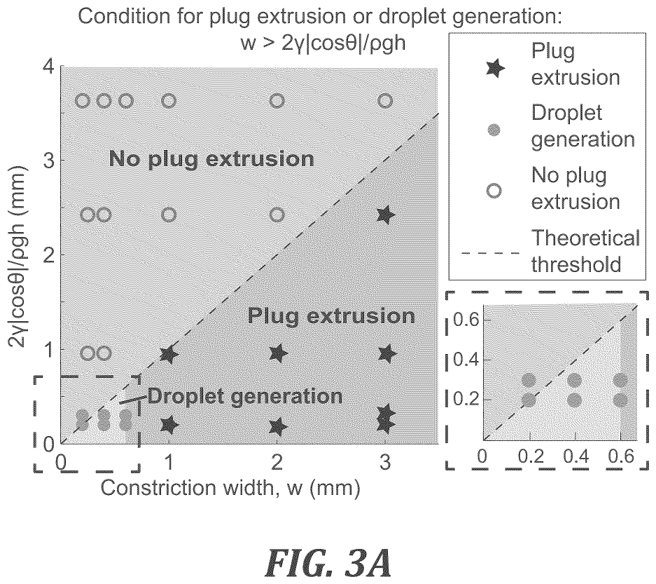

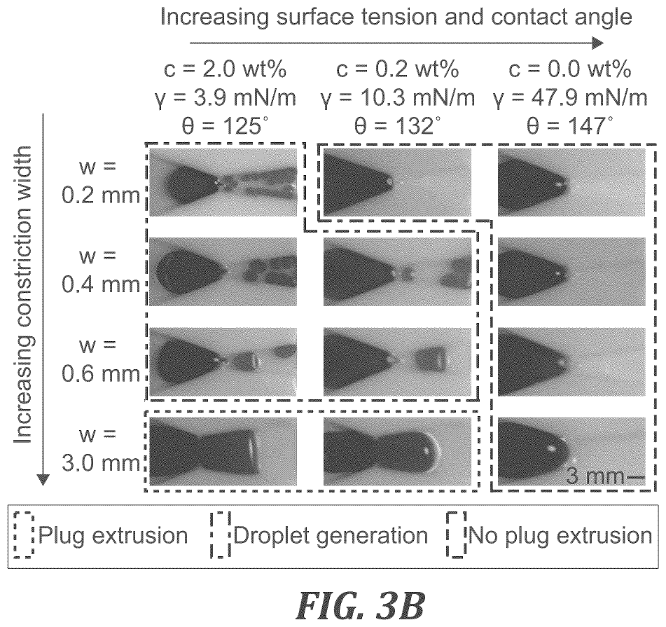

Contact angles and interfacial tension values reported in FIGS. 3A and 3B were measured on a Kruss Drop Shape Analyzer model DSA025 (Kruss GmbH). Contact angles of the aqueous droplet on the PTFE substrate were measured using the sessile droplet method. When needed, the sessile droplet method is conducted with the sessile droplet submerged in a second liquid to measure the contact angle in a quartz cuvette. In this experiment, the droplet was DIW with blue dye submerged in HFE7500 at various FS concentrations (0 wt %, 0.002 wt %, 0.02 wt %, 0.2 wt %, or 2 wt %) and the substrate was PTFE.

Interfacial tension was measured using the pendant drop method where the fluid body is deposited by a motorized syringe pump until it achieves a pendant shape. From deriving the force balance between the interfacial tension and gravity, the interfacial tension is extracted from the droplet shape. When needed, the pendant drop method is conducted with the pendant drop submerged in a second liquid to measure the interfacial tension in a quartz cuvette. In this experiment, the droplet was DIW with blue dye submerged in HFE7500 at various FS concentrations (0 wt %, 0.002 wt %, 0.02 wt %, 0.2 wt %, or 2 wt %).

Droplet Volume Determination.

A custom MATLAB script was written to determine the droplet volume. Using image processing, droplets were identified in the experimental videos and the area they encompass was calculated by counting the number of pixels of the droplet. From there, we calculated the effective diameter of the droplets from the area and depending on if droplet diameter was larger than channel height h, the droplets were approximated as either spherical or cylindrical shape. When droplet diameter is less than the channel height, droplets have a spherical-like shape and when droplet diameter is larger than the channel height, droplets have a cylindrical-like shape. To calculate droplet volume:

If droplet diameter is larger than channel height h,

V=πr²h (3)

If droplet diameter is smaller than channel height h,

$$V = \frac{4}{3} π {r}^{3} \qquad ( 4 )$$

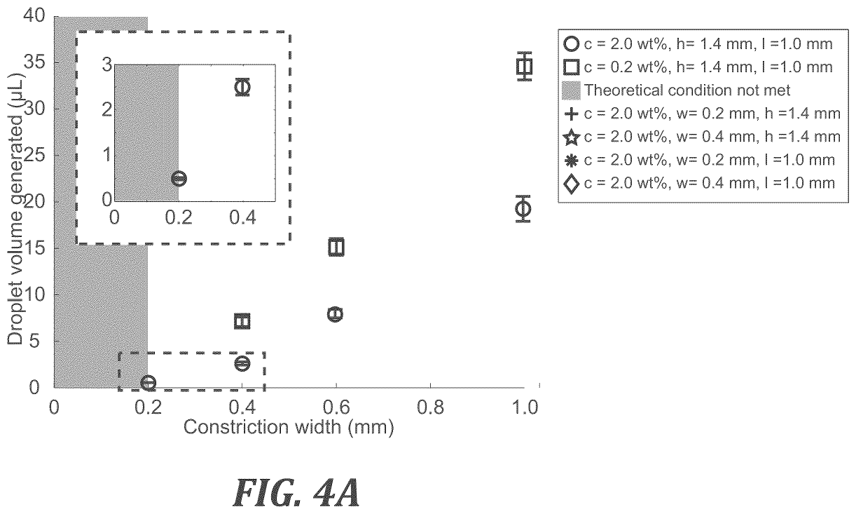

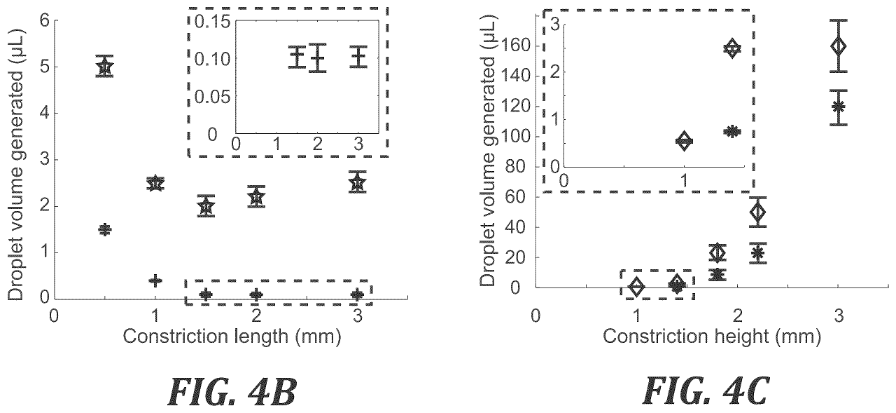

N≥90 droplets were analyzed per data point. The mean (markers) and standard deviation (error bar) of the droplet volume are plotted in FIGS. 4A-4C.

This method of computing droplet volume is an estimation from fitting droplets to simple shapes (sphere and cylinder) and was determined to be satisfactory (R²=0.9799) for this work as the droplets do not spread much. The overestimation is due to the droplets spreading out as Bond number increases making its droplet height shorter which is not accounted for by the code.

Droplet Sorting and Merging (FIGS. 6A, 6B, 6C, 7A, & 7B).

For transporting a droplet, either a pair of tweezers or a PTFE bead attached to a stylus was used. The stylus was 3D-printed with grey resin (RS-F2-GPGR-04, Formlabs Inc.) and has a ⅛″ PTFE ball (McMaster-Carr Supply Co.) adhered to the tip with silicone sealant (Gorilla, Maine Wood Concepts Inc.). The tweezers were a pair of PTFE tweezers with slim, rounded, and smooth tips (McMaster-Carr Supply Co.). For merging droplets, a stainless-steel stitching needle (AEHO crafts) or medical grade No. 22 hypodermic needle was used.

KSCN and Fe(NO₃)₃ Aqueous Solution Preparation (FIG. 8).

Green food dye (McCormick Corp.) was added to solutions of 0.1 M of KSCN (Thermo Fisher Scientific Corp.) and 0.05 M of Fe(NO₃)₃ (Thermo Fisher Scientific Corp.) until they were approximately the same shade of blue. KSCN is clear while Fe(NO₃)₃ is yellow which is why the blue food dye was not added by exact measurements. The workflow of droplet generation, selection, fusion, and sorting (FIGS. 8B, 8C, and 8D) is described in the results section.

### Example 2: Autonomous Droplet Generation in an Open Microfluidic Channel

The droplet generation platform of the present disclosure demonstrates the ability to autonomously generate droplets without intervention, and the open surface nature of our channel provides direct access to manipulate droplets (FIG. 1). Generating droplets in an open channel is challenging because typical droplet generators operate by utilizing pumps to forcefully flow an aqueous and carrier phase through microchannels to shear off aqueous droplets. In an open channel, these pressures and flow rates would cause the fluid to spill out of the channel and thus the challenge becomes: how can droplets form without the high flow rates in a closed channel and with entirely passive capillary forces. The method of the present disclosure for generating droplets is an important new tool for users who do not find traditional droplet generator setups approachable. In addition, the simplicity in operation is advantageous for those who would like a medium throughput and sample size (hundreds to thousands) method to generate droplets and do not necessarily need high throughput and sample size. There are five regions in the device; the origin of flow is at the (1) inlet reservoir which leads to the (2) converging region, followed by the (3) narrow constriction, (4) diverging region, and (5) outlet reservoir. The operation of the device is simple; the aqueous solution is pipetted into the converging region creating an aqueous plug. The front end of the plug meets the narrow constriction, and the plug is in full contact with the channel walls (FIG. 1d, left). Next, the carrier fluid, a fluorinated oil, is pipetted in the inlet reservoir to establish a hydrostatic pressure that pushes the aqueous plug into the narrow constriction (0.2 mm-3 mm in width) (FIG. 1d, middle). As the front portion of the aqueous plug exits the narrow constriction, it pinches off into small droplets in the diverging region and flows to the outlet reservoir (FIG. 1d, right). The angles of the converging and diverging region (45° and 20° respectively) were found to generate the most consistent and monodisperse droplets. Furthermore, a pair of square protrusions forms the narrow constriction which creates a large capillary pressure to oppose the hydrostatic pressure of the carrier fluid at the inlet reservoir. Hydrostatic pressure is governed by the carrier fluid height (determined by the dimensions of the device) and density, while capillary pressure is governed by interfacial tension, contact angle, and meniscus radius of curvature. As carrier fluid fills the inlet reservoir the hydrostatic pressure increases. At the narrow constriction and converging-diverging region there is a 0.2 mm tall step with grooves on both sides to allow carrier fluid to flow past the aqueous plug and prewet the channel walls prior to droplet generation. The low contact angle of the carrier fluid on the polytetrafluoroethylene (PTFE) channel surface enables prewetting of the channel walls by SCF which was found to be essential for continuous droplet generation resulting in hundreds of droplets at the outlet (FIG. 1b). In addition, continuous droplet generation of multiple aqueous phases can be performed in parallel on the same device (FIG. 1c).

The present disclosure describes the use of PTFE as the channel material. Previously, in our open channel, channels were fabricated from poly(methyl methacrylate) (PMMA) and could only transport water droplets with organic solvents which is not ideal for applications of droplet microfluidics because organic solvents are often cytotoxic and known to remove small molecules from the droplets. In other words, using a carrier fluid that is not toxic and possess desirable interfacial properties was essential to furthering biological applications of our technology. The wetting properties of fluorinated oil, HFE 7500, on PTFE and the high contact angle of the aqueous plug allowed for droplet generation and manipulation (FIG. 1E) to occur in our channel. Fluorinated oils are ideal for life science applications in droplet-based microfluidics because of their biocompatibility—they have been used in applications ranging from human cell culture to digital droplet polymerase chain reaction (ddPCR). The droplet throughput demonstrated here is around 2 droplets/second with the parameters utilized here. Further optimization of contact angle through the use of other materials or coatings, surface tensions through the use of surfactants and other reagents, and channel dimensions through the use of more precise fabrication methods and materials will enable an improvement on these results.

### Example 3: Condition for Droplet Generation

Droplet generation occurs when the aqueous plug overcomes the difference between hydrostatic and capillary pressure which pushes it into the narrow constriction. It is important to note that this does not happen at any hydrostatic and capillary pressure and occurs in a small region that gives the precise condition to generate droplets (discussed further below). To note, a non-wetting plug should move spontaneously away from convergent geometries when no external forces of parallel direction are applied, and in our channel design, the hydrostatic pressure resulting from the carrier fluid is able to counteract this tendency. Based on empirical observation from high-speed videos, the front portion of the aqueous plug is initially settled at the narrow constriction. As the front portion of the aqueous plug advances into the narrow constriction (plug advancement phase) it forms a bulbous shape (bulbing phase). Next, a liquid thread is formed (thread formation phase in FIG. 2A and red arrow depicting the thread in FIG. 2B), and the liquid thread diameter decreases until it pinches off and droplet formation occurs (pinch off phase).

FIG. 2B shows the droplet formation process for various surfactant concentrations, c, and constriction widths, w. We observed that the phases of the droplet formation process are nearly identical across the various surfactant concentrations and constriction widths used in this study (FIG. 2B). We also observe that the constriction geometry and surfactant concentration is a determining factor in the final droplet volume generated. This droplet formation process is distinct from droplet formation in conventional droplet microfluidics in which pressure-driven flows is the norm (e.g., it is assumed that pressure-drive flow near the wall has no slip condition but this is not a good assumption for the flow in SCF as it is driven by the wetting of the channel walls). Since there are no theoretical models that describe this particular droplet formation accurately, a derivation is proposed to determine the threshold that causes droplet formation. This is a first step in understanding this type of droplet formation. For the aqueous plug interface to extend past the narrow constriction, the hydrostatic pressure, ρgh at the back of the plug must overcome the capillary pressure, γ_{1,2}(1/Rₚₒₛ−1/Rₐₙₜ) (FIG. 2C). Then, two possible outcomes occur: plug extrusion or droplet generation. We define plug extrusion as the entire aqueous plug passing through the constriction and sometimes breaking into two or three segments when exiting the diverging region. Droplet generation is a consistent generation of droplets pinching off from the aqueous plug with a relative standard deviation in volume of 5%-7%. The pressure difference when the aqueous plug interface extends past the narrow constriction is:

$$ρ g h + {γ}_{1 , 2} ( \frac{1}{{R}_{p o s}} - \frac{1}{{R}_{a n t}} ) > 0 \qquad ( 1 )$$

capillary pressure resulting in the aqueous plug being extruded or generating droplets at the constriction.
where g is the gravitational acceleration, γ_{1,2} is the interfacial tension between carrier fluid and aqueous plug, ρ is the carrier fluid density, Rₚₒₛ is the radius of curvature of the back of the plug interface, and Rₐₙₜ is the radius of curvature of the front of the plug interface. The left-hand side of Eq. (1) must be greater than 0 for the aqueous plug interface to extend past the narrow constriction.

By rearranging the pressure difference involving the hydrostatic pressures and capillary pressures, the condition for the aqueous plug extrusion or droplet generation is:

$$w > \frac{2 {γ}_{1 , 2} \vert cos cos {θ}_{1 , 2 , s} \vert}{ρ g h} \qquad ( 2 )$$

where w is the constriction width, θ_{1,2,s} is the contact angle between aqueous plug, carrier fluid, and channel wall, and h is the carrier fluid height. Based on experimental observation, the aqueous plug height is equal to the carrier fluid height.

As explained previously, droplet generation occurs when conditions are met to achieve the correct balance between capillary and hydrostatic pressure. We developed design rules to determine when this regime occurs. We display the theoretical threshold for when the aqueous plug extrusion or droplet generation occurs in a regime map (FIG. 3A dashed line per Eq. (2)) at varying interfacial tension, contact angle, constriction width, and constriction height. In FIG. 3A, we observed empirically that there exists a well-defined region (teal shaded region) where droplet generation occurs when constriction width is small (ω≤0.6 mm) and the condition in Eq. (2) is met. In the droplet generation region (teal shaded region), the constriction width w, the channel height h, interfacial tension γ_{1,2}, and contact angle θ_{1,2,s} are the four factors that determine the volume of the droplets formed when carrier fluid density remains constant. The γ_{1,2} and θ_{1,2,s} is varied by the concentration of the surfactant, c. We observed that at a constriction width of 0.2 mm, when γ_{1,2} (purple shaded region), droplet generation (teal shaded region), and no plug extrusion (red shaded region). Full table of parameters available in Table S1. An inset is included for better clarity of the droplet generation region. b Montage of plug extrusion and droplet generation when varying constriction width, fluorinated surfactant concentration (c, wt %), interfacial tension γ_{1,2}, and contact angle θ_{1,2,s}. and θ_{1,2,s} increases (due to lowering fluorinated surfactant (FS) concentration from 2.0 wt % to 0.2 wt % or lower), the front portion of the aqueous plug cannot enter the narrow constriction and no plug extrusion occurs (FIG. 3B). However, the aqueous plug can extrude from the narrow constriction if the constriction width increases to 0.4 mm at a FS concentration, c, of 0.2 wt %. This observation matches Eq. (2) and the regime map at FIG. 3A; when γ_{1,2} and θ_{1,2,s} increases, the minimum width that allows plug extrusion is larger as well. Note that plug extrusion is possible without droplet generation (w=3.0 mm, c≥0.2 wt %). At the highest γ_{1,2} and θ_{1,2,s} (0.0 wt % FS), the front portion of the aqueous plug cannot enter the narrow constriction for any of the constriction width dimensions tested, thus plug extrusion does not occur (FIG. 3B, consistent with the phase diagram in FIG. 3A).

FIGS. 4A-4C shows the generated droplet volume as a function of constriction width, surfactant concentration, constriction length, and constriction height (data point presented as mean±SD, n≥90). FIG. 4A depicts the effect of surfactant concentration (c=2 wt % and c=0.2 wt %) and constriction width (w=0.2 mm and w=0.4 mm) on generated droplet volume. The droplet volume generated increases with increasing constriction width w and decreasing surfactant concentration (interfacial tension γ_{1,2} and contact angle θ_{1,2,s}). Similarly, when varying constriction length, l at w=0.2 mm and w=0.4 mm, we found that the generated droplet volume decreases as constriction length increases (FIG. 4B). However, it is important to note that the standard deviation of the generated droplet volume is much larger when the constriction length is larger than 1 mm. When varying constriction height, h at w=0.2 mm and w=0.4 mm, we found that the generated droplet volume increases as constriction height increases (FIG. 4B).

Overall, the smallest droplet volume generated in our experiments is 0.10±0.018 μL and w=0.4 mm is 2.39±0.175 μL. The relative standard deviation of our droplet generation method ranges between 5% and 7% while conventional methods range between 1% and 3% which shows that the monodispersity of our system is relatively close to conventional methods, with room for improvement. We believe the relative standard deviation can be reduced if we have better control of maintaining relatively constant hydrostatic pressure, a focus of future redesigns. We also note that the physics underlying the droplet formation process is scalable to smaller length scales, therefore smaller droplet volumes will be achievable in future work if alternative fabrication processes such as advanced CNC milling or cleanroom fabrication processes are used to create devices with smaller constriction widths. Here, we chose 0.2 mm as the minimum constriction width due to the limitations of our current CNC milling process.

### Example 4: Downstream Droplet Manipulation in Open Microfluidic Devices

Droplet manipulation is essential for utilizing droplet microfluidics to study biology and chemistry because it enables the selection of specific droplets for mixing, splitting, and sorting. This control ultimately provides the researcher with the ability to perform many permutations of reactions at the time they choose. We demonstrate droplet manipulations to present the possibilities of conducting future biological and chemical studies with this device. In open systems, contamination and evaporation may be problematic if not controlled. Evaporation of the carrier fluid or aqueous phase can cause changes in the hydrostatic pressure conditions that are essential for droplet generation. Methods to address evaporation and contamination such as secondary containment and sacrificial liquid droplets or wells have been successfully employed with primary human samples and can be used with our autonomous open droplet generator. The open surface of the device enables us to create new methods to physically move the droplets such as using specialized tweezers or a needle to reach into the device and move or mix targeted droplets chosen in real-time at the discretion of the researcher. We use these manipulations for chemical reactions followed by droplet sorting.

Droplet transport and droplet sorting is an integral component of droplet microfluidics workflows. Traditional droplet microfluidics controls the direction of the droplet flow by controlling flow rates and/or integrating design features in the closed channel. The manipulations need to be predetermined to program the droplet microfluidic device before the experiment which leaves little room for experimental modification throughout the experiment. We developed a complementary method to the autonomous droplet generator to selectively transfer single droplets to locations both on and off the open droplet generating device by picking them up with PTFE-coated tweezers or moving them with a PTFE stylus. The PTFE-coated tweezers and styli transport droplets laterally by utilizing the Cheerios effect, which is the phenomenon of multiple objects aggregating due to the objects deforming the liquid interface (FIG. 5A). The PTFE-coated tweezers and styli are placed at the surface of the carrier fluid, causing the carrier fluid to wet the tweezers or stylus and form a rising interface. The droplets are buoyant and when they are near the meniscus created by the tweezers or stylus they then move toward the upward rising fluid interface. Additionally, once the droplet is captured between the tweezers, the droplet rises up the tweezers due to the tendency for droplets to move towards divergent geometries (FIG. 5B). This allows droplets to be picked up and transferred to another location (e.g., well plate). To detach the droplet from the tweezers or stylus the user can abruptly move it away from the droplet which causes detachment due to inertia. Further, walls or other features (FIGS. 5C, 6B, and 6C) have menisci which enables droplets to again move up the rising interface to rest on the wall. We found that the ability to handle droplets with the tweezers and styli is easy to acquire and no more difficult than handling a pipette. New users may use multiple tries to move droplets from one location to another but there were no major difficulties in handling the droplets or breaking the droplets during transport.

PTFE tools are important for droplet transport because the PTFE prevents the aqueous droplet from strongly adhering to the tweezers, facilitating droplet release. Using a similar mechanism, we use a stylus with a PTFE bead adhered to the tip to gently move droplets around the reservoir for sorting and patterning droplets (FIGS. 6B and 6C). To summarize, the PTFE stylus enables lateral droplet transport and the PTFE-coated tweezers enables both lateral droplet transport and vertical droplet transport (i.e., picking up droplets). In future work, this approach could be used to sort droplets based on a reaction outcome or transfer droplets to a different part of a chip for further use in analysis or reactions.

While we focused on moving individual droplets to highlight the ability to move droplets selectivity, this method can be multiplexed using an array of styli (for example, a three-pronged stylus could be used to move three droplets at once from the columns of the array similar to FIG. 6C). The direct access to the droplets is unique to our open channel systems and allows users to directly extract and/or manipulate the contents of the channel. This is enabling for users who cannot transfer them to a well plate with PTFE-coated tweezers. b Sorting droplets into individual chambers with a PTFE ball mounted on a stylus. c PTFE stylus is used to transfer droplets to the “UW” pillar rely on power-heavy solutions in conventional droplet microfluidics like acoustophoresis, electrophoresis, and electrowetting-on-dielectric (EWOD) or users who would like the flexibility to manipulate droplets at any point in their device, without the need to pre-pattern electrodes.

For applications requiring automation, this method could be automated by mounting the stylus on a robotic XYZ controller interfaced with a fluorescent or colorimetric readout in the droplets to facilitate sorting based on a chemical/biochemical readout. The flexibility to move droplets on demand—both on- and off-chip—shows great promise for being able to conduct multistep chemical and biological experiments and incorporating analytical readouts that are best implemented outside of the original microfluidic chip embodiment.

In FIG. 6C, the generated droplets are patterned by transporting them toward the “UW” feature using a PTFE bead to outline the feature. It is important to note that droplets were transported to sharp corners of the “W” with ease using the PTFE bead. In contrast, traditional droplet microfluidics would require pumps and valves to change the trajectory of the droplets. Furthermore, our channel design is not constrained by requiring prior knowledge of the location to which the droplets will be transported. This allows our channel design to be modular by being able to continuously upgrade or add new features (e.g., replacing “UW” feature with another feature) directly on the channel. Open microfluidics can be leveraged to make droplet studies user-friendly, customizable, and adaptable for integration of physical probes and tools downstream.

The ability to take small aliquots of a droplet after it is generated is useful for downstream analysis or processing steps, particularly when working with small volumes of precious reagents. We demonstrated that we can split smaller droplets off from a large aqueous plug with notches along the outlet reservoir wall (FIG. 7A). In this case, the constriction allows aqueous plug to extrude and flow along the notches. As the plug travels along the notches via SCF, it fills the notch; as the back end of the large plug fully passes the notch it shears off leaving the notch filled with a small droplet. The droplets in the notches can then be retrieved with a pipette for individual analysis resulting in 40+ data points from one large plug.

In FIG. 7B, two droplet merging is demonstrated by disrupting the interface of the droplets using a simple needle. The needle is moved back and forth between the two droplets to disrupt their interface resulting in their merging. Our new fusion method enables users to induce fusion on demand at any location in the open device; the location need not be decided prior to the experiment. The open device gives the user complete control over when and where droplets merge. In future droplet splits off and remains in the notch. b A yellow and blue droplet are merged by mixing with a needle to form a green droplet.

The merging step could also be automated using a needle mounted on an XYZ controller as described for the droplet transport with tweezers and styli mentioned above. This merging technique with the automated system makes it comparable to prior droplet fusion methods (such as electrofusion or fusion based on electrowetting on dielectric), which often require the placement of specific components (e.g., electrodes) in the device design.

### Example 5: Sorting Reacted Products in Droplets

Droplet merging and sorting makes possible applications for chemical reactions, biochemical assays, and other multi-reagent processes which are just a few of the applications that leverage the strength of droplet microfluidics. Selective droplet merging is demonstrated in FIGS. 8B-8D using droplets of KSCN and Fe(NO₃)₃ mixed with blue dye for visualization. Upon successful mixing, the mixed droplet turns red. Droplets of the two reagents are formed using two parallel open-channel droplet generators. Then, two droplets are randomly if a colored complex (Fe(SCN)₃) forms, the droplet is sorted to the reacted chamber; droplets without Fe(SCN)₃ are sorted to the unreacted chamber.

selected from the outlet reservoir and transported to a platform with a pair of PTFE-coated tweezers (yielding three possible combinations: two droplets containing KSCN, two droplets containing Fe(NO₃)₃, or a droplet containing KSCN and a droplet containing Fe(NO₃)₃). On the platform, the droplets are merged by disrupting the interfaces of the droplet pair with a needle. When a droplet containing KSCN and a droplet containing Fe(NO₃)₃ merge, they change color from blue to red due to the formation of Fe(SCN)₃. Merged droplets are then sorted to chambers categorized by reacted and unreacted droplets using PTFE-coated tweezers.

The purpose of this proof-of-concept workflow is to demonstrate the ability to perform a reaction and sort droplets based on “hits” (in this case droplets containing the reaction product Fe(SCN)₃). This suggests the potential for conducting droplet sorting tasks in applications like single cell encapsulation, directed evolution of enzymes, and process optimization of synthetic reactions to synthesize small molecules or novel materials.

### Example 6: Discussion

We demonstrate here an open droplet microfluidic device that enables autonomous generation of droplets by utilizing capillary forces in open channels. By virtue of being open, these platforms allow easy manipulation of droplets (including patterning, transferring, splitting, merging, and sorting) via unobstructed access to the droplets along the entire length of the device. We further demonstrate a set of droplet manipulation methods that leverage the open nature of the channels and use surface tension forces to move, sort, and merge droplets. The open microfluidic droplet generator method demonstrated here proves the feasibility of using capillary forces to generate droplets autonomously. We acknowledge that the current method is advantageous for those who would like a medium throughput and sample size (hundreds to thousands) technique for droplet generation and that additional optimization is the subject of future work—chiefly, the number of droplets generated (2 droplets/second) is not at the level of high throughput droplet microfluidic devices where droplets are generated at thousands of droplets per second. Pathways for optimization include surface tension, contact angle, and channel dimension explorations to facilitate droplet generation as well as create larger surface-tension forces driving faster flow rates. The method presented here has currently been demonstrated with PTFE as the microchannel material, though other materials would be possible to use either directly or with surface modification to increase the hydrophobicity.

One advantage of open microsystems is that the surfaces of the channel can easily be treated through a range of methods (e.g., dip coating, chemical vapor deposition) making optimizations of contact angles simple and reliable. The use of PTFE or other fluoropolymers is advantageous, however, as they are biocompatible materials suitable for biological applications and have excellent solvent compatibility for chemical applications.

Despite the limitations of the current embodiment, certain applications are uniquely enabled by the open channel aspect of the platform—such as the ability to manipulate droplets with implements like tweezers or a needle and the ability to add and remove solid objects like beads or pieces of tissue—that are suited for medium-throughput and medium-sample size (hundreds to thousands of droplets in total) experiments. An attractive opportunity for this technology is the ability to rapidly test and prototype droplet systems with a very low engineering and manufacturing complexity as well as interface the channel with traditional fluidic handling systems to input reagents fluids (e.g., cell culture media, reagents) or recover a select set of droplets. Furthermore, the ability to parallelize the channel without adding pumps to drive the flow allows for the droplet generation to be scaled up without adding additional equipment for each new droplet generator. In future work, we will explore fabricating these channels with optically transparent fluoropolymers such as fluorinated ethylene propylene (FEP). Our method further makes possible numerous areas for future work—both on biological and chemical applications and in further understanding the physics underlying droplet formation and droplet transport via the Cheerios effect. Finally, this design is a first step in exploring the space of power-free autonomous open droplet microfluidic devices and provides design rules for similar channel designs. The theory provided in this article provides a foundation for understanding this type of droplet formation; further work is required to fully understand and exploit this new droplet formation phenomenon.

While illustrative embodiments have been illustrated and described, it will be appreciated that various changes can be made therein without departing from the spirit and scope of the invention.

1. A fluidic device for autonomous droplet generation, the fluidic device comprising:
a substrate defining:
an inlet reservoir shaped to receive and to carry a carrier liquid;
a converging region in fluidic communication with the inlet reservoir and shaped to receive a liquid sample;
a constriction adjacent to and in fluidic communication with the converging region, wherein the constriction defines a pathway configured to allow passage of fluid therethrough;
a diverging region in fluidic communication with and downstream of the constriction; and
an outlet reservoir in fluidic communication with the diverging region,
wherein the fluidic device does not comprise a portion covering the outlet reservoir opposite the substrate.

2. The fluidic device of claim 1, wherein the constriction comprises a pair of protrusions extending from the converging region and the diverging region.

3. The fluidic device of claim 1, wherein a portion of the substrate including the constriction comprises a floor, and wherein the floor defines one or more grooves shaped and positioned to transport a carrier liquid between the converging region and the diverging region.

4. The fluidic device of claim 1, wherein a width of the constriction is in a range of about 0.2 mm to about 3 mm.

5. The fluidic device of claim 1, wherein the substrate comprises a hydrophobic material.

6. The fluidic device of claim 5, wherein the hydrophobic material is configured such that a droplet of an aqueous solution in contact with the hydrophobic material has a contact angle in a range of about 90° to about 180°.

7. The fluidic device of claim 1, wherein the outlet reservoir defines a floor and a wall encircling at least a portion of the floor, wherein the outlet reservoir is configured to receive and carry droplets generated at the constriction.

8. The fluidic device of claim 7, wherein the wall defines a plurality of crenulations shaped to generate a droplet within interstices of a crenulation of the plurality of crenulations.

9. The fluidic device of claim 7, wherein the floor defines one or more structures shaped to adhere to a droplet generated at the constriction.

10. The fluidic device of claim 9, wherein the one or more structures includes one or more chambers shaped to receive the droplet.

11. The fluidic device of claim 1, wherein the inlet reservoir is a first inlet reservoir, wherein the constriction is a first constriction, wherein the converging region is a first converging region, and wherein the diverging region is a first diverging region, wherein the fluidic device further comprises:
a second inlet reservoir shaped to receive and to carry the carrier liquid;
a second converging region in fluidic communication with the second inlet reservoir and shaped to receive a second liquid sample;
a second constriction adjacent to and in fluidic communication with the second converging region;
a second diverging region in fluidic communication with and downstream of the second constriction,
wherein the second diverging region is shaped and positioned to transport droplets generated at the second constriction to the outlet reservoir.

12. The fluidic device of claim 1, wherein the fluidic device does not comprise a pump or other powered devices configured to urge liquid through the constriction to generate droplets therewith.

13. A kit for autonomous droplet generation, the kit comprising:
a fluidic device claim 1; and
a carrier liquid.

14. The kit of claim 13, further comprising a droplet manipulation instrument configured to move a droplet within the carrier liquid, wherein the droplet manipulation instrument is selected from the group consisting of tweezers, a stylus, a needle, and combinations thereof.

15. The kit of claim 14, wherein a portion of the droplet manipulation instrument is coated in a material comprised in the substrate of the fluidic device.

16. The kit of claim 13, wherein a droplet of the carrier liquid in contact with the substrate has a contact angle in in a range of about 0° to about 90°.

17. The kit of claim 13, wherein a width, w, of a constriction of the fluidic device is according to the following equation:
$$w > \frac{2 {γ}_{1 , 2} \vert cos cos {θ}_{1 , 2 , s} \vert}{ρ g h}$$
where g is the gravitational acceleration, γ_{1,2} is an interfacial tension between the carrier liquid and a liquid sample, ρ is a carrier liquid density, Rₚₒₛ is a radius of curvature of a back of the liquid sample, and Rₐₙₜ is a radius of curvature of a front of the liquid sample, θ_{1,2,s} is a contact angle between aqueous plug, carrier liquid, and channel wall, and h is a carrier liquid height in the inlet reservoir.

18. The kit of claim 13, further comprising one or more surfactants.

19. A method of autonomous droplet generation, the method comprising:
introducing a liquid sample into a converging region shaped to receive the liquid sample; and
introducing a carrier liquid into an inlet reservoir shaped to receive and to carry the carrier liquid, wherein the converging region is in fluidic communication with the inlet reservoir, thereby urging the liquid sample through a constriction adjacent to and in fluidic communication with the converging region and generating droplets into a diverging region in fluidic communication with and downstream of the constriction and an outlet reservoir in fluidic communication with the diverging region,
wherein the fluidic device does not comprise a portion covering the outlet reservoir.

20. The method of claim 19, wherein the method is performed using a fluidic device of claim 1.

21. The method of claim 19, wherein the liquid sample is a sperm sample.

22. A method of droplet manipulation, the method comprising:
introducing a droplet manipulation instrument into a carrier liquid in which the droplet is disposed, wherein the droplet has a lower density than the carrier liquid, and wherein the carrier liquid wets the droplet manipulation instrument; and
translating the droplet manipulation instrument through the carrier liquid adjacent to the droplet, thereby translating the droplet through the carrier liquid.

23. The method of claim 22, wherein the droplet is generated according to the method of claim 19.

24. The method of claim 22, further comprising merging the droplet with another droplet.
